(19) United States
(12) Patent Application Publication
(10) Pub. No.: US 2004/0216720 A1
(43) Pub. Date: Nov. 4, 2004

(54) Fuel injection device for internal combustion engines

(76) Inventors: Peter Boehland, Marbach (DE); Sebastian Kanne, Stuttgart (DE); Godenhard Nentwig, Stuttgart (DE)

Correspondence Address: Striker Striker & Stenby, 103 East Neck Road, Huntington, NY, 11743, US

(21) Appl. No.: 10/472,623

(22) PCT Filed: Feb. 14, 2003
(86) PCT No.: PCT/DE03/00445

(30) Foreign Application Priority Data
Apr. 24, 2002 (DE) 102 18 219.1

(51) Int. Cl. F02M 1/00

(52) U.S. Cl. 123/447

(57) ABSTRACT

The invention proposes a fuel injection apparatus with a fuel injection valve, wherein the fuel injection valve has at least one injection opening and at least one valve element for closing the at least one injection opening, wherein the valve element is controlled by means of a servohydraulic valve (131), wherein the servohydraulic valve has a control piston (123) that is supported in moving fashion, wherein the control piston disconnects a control chamber (116) from a high-pressure chamber (120), wherein at least one first partial region (117) of the control chamber (116) can be emptied in every position of the control piston (123) via a line (110) provided with an outlet throttle (113), and wherein at least one second partial region (119) of the control chamber can be filled with fuel in every position of the control piston via an inlet throttle (115) so that depending on the filling of the control chamber (116), in a first position, the control piston (123) disconnects a first connection (125) of the high-pressure chamber from a second connection (127) of the high-pressure chamber and in a second position, connects the first connection to the second connection so that the valve element (35) can be controlled in accordance with the position of the control piston (123), wherein means (150, 151, 152, 137; 150, 151, 152, 180; 150, 190, 192; 150, 190, 250, 252; 150, 151, 300, 302) are provided in order to be able to use the fuel pressure prevailing in at least one of the partial regions (117, 119) of the control chamber (116) for controlling another moving element (37) of the fuel injection apparatus.

### PRIOR ART

The invention is based on a fuel injection apparatus with a fuel injection valve according to the preamble to the independent claim. Although DE 41 15 477 A1 has already disclosed an apparatus of this kind, it requires two separate electrically controllable actuators for a two-part valve needle.

### ADVANTAGES OF THE INVENTION

The fuel injection apparatus according to the invention, with the characterizing features of the independent claim, has the advantage over the prior art that only one electrical actuator is required in order to control two moving elements of the apparatus. In this connection, it is particularly advantageous that an already existing control chamber pressure of a servohydraulic valve can be used to inexpensively achieve an additional switching function without using an additional electrical actuator. At least two switching positions can be advantageously provided for this additional actuator as a function of the position of the control piston.

Other advantages and advantageous embodiments of the subject of the invention can be inferred from the specification, the drawings, and the claims.

### DRAWINGS

Exemplary embodiments of the invention are shown in the drawings and will be explained in detail in the description that follows.

FIG. 1 shows a fuel injection apparatus with two control valves that can be electrically triggered separately, which is known from the German patent application with the serial number 10058130.7, submitted on Nov. 22, 2000,

FIG. 2 shows a detail of the known apparatus,

FIG. 3 shows a detail of a first exemplary embodiment,

FIG. 4 shows a detail of a second exemplary embodiment,

FIG. 5 shows a detail of a third exemplary embodiment,

FIG. 6 shows a detail of a fourth exemplary embodiment, and

FIG. 7 shows a detail of a fifth exemplary embodiment of the invention.

### DESCRIPTION OF THE EXEMPLARY EMBODIMENTS

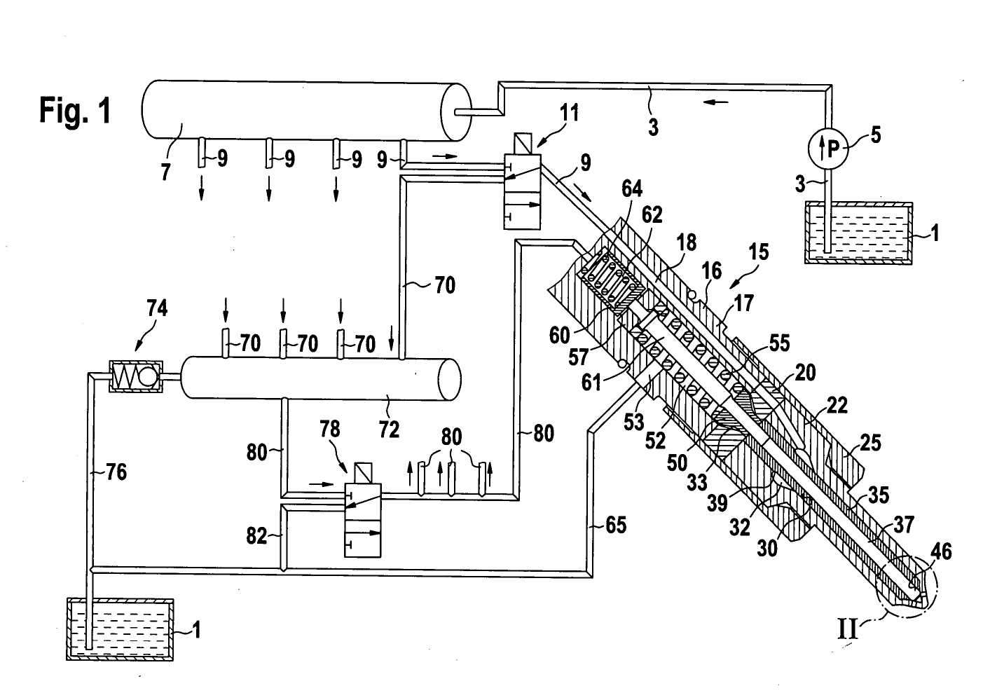

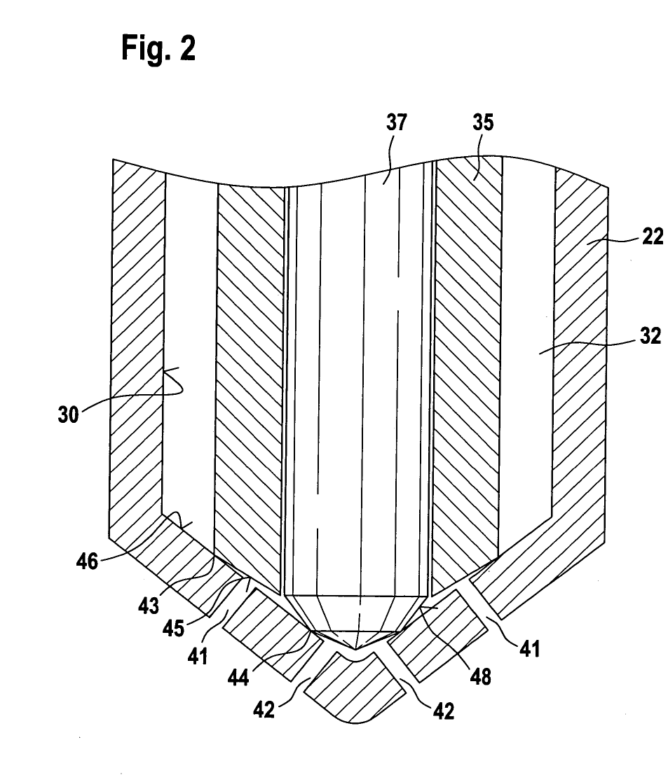

FIG. 1 schematically depicts a fuel injection apparatus for internal combustion engines; a fuel injection valve 15 is depicted in longitudinal section and the remaining components of the fuel injection system are depicted schematically. Fuel is supplied via a fuel line 3 from a fuel tank 1 to a high-pressure pump 5, which supplies it via the fuel line 3 to a high-pressure accumulation chamber (common rail) 7. A regulating device not shown in the drawing assures that a predetermined high fuel pressure level is maintained in the high-pressure accumulation chamber 7. High-pressure lines 9 lead from the high-pressure accumulation chamber 7 and can each be connected to a fuel injection valve 15. Only one of these fuel injection valves 15 is shown in FIG. 1. The high-pressure line 9 is connected to a high-pressure valve 11 that is embodied as a 3/2-port directional-control valve. From the high-pressure valve 11, the high-pressure line 9 continues on to the fuel injection valve 15. The fuel injection valve 15 has a housing 16 that is comprised of a valve holding body 17, an intermediary disk 20, and a valve body 22; a retaining nut 25 clamps the valve body 22 and the valve holding body 17 to each other in the axial direction, with the intermediary disk 20 disposed between them. The valve body 22 contains a bore 30, in which a valve needle in the form of a hollow needle 35 is guided so that it can slide longitudinally. A valve seat 46 is embodied at the combustion chamber end of the bore 30 and has two rows of injection openings 41, 42 provided in it that are offset from one another in the axial direction. One row of injection openings 41, 42 here is comprised of a number of injection openings that are preferably distributed uniformly over the circumference of the valve body 22. FIG. 2 shows an enlarged depiction of FIG. 1 in the vicinity of the valve seat 46. The hollow needle 35 is guided in a sealed fashion in a section of the bore oriented away from the combustion chamber and tapers toward the combustion chamber, forming a pressure shoulder 39 that serves as a pressure surface. At the combustion chamber end, the hollow needle 35 transitions into an outer sealing surface 45, which is embodied essentially in the form of a cone so that at the transition of the outer circumference surface of the hollow needle to the sealing surface 45, an outer sealing edge 43 is formed, which rests against the valve seat 46 in the closed position of the hollow needle 35. At the level of the pressure shoulder 39, a radial expansion of the bore 30 forms a pressure chamber 32 in the valve body 22, encompassing the hollow needle 35 and extending to the valve seat 46. The pressure chamber 32 can be connected via the high-pressure line 9 to the high-pressure accumulation chamber 7 by means of an inlet conduit 18 extending in the valve body 22, the intermediary disk 20, and the valve holding body 17. The first row of injection openings 41 in the valve seat 46 is positioned in such a way that the sealing edge 43 of the hollow needle 35 seals the first row of injection openings 41 off from the pressure chamber 32 so that when the hollow needle 35 rests against the valve seat 46, no fuel is injected.

At its end oriented away from the combustion chamber, the hollow needle 35 rests against a spring collar 50, which is contained in a central opening 33 provided in the intermediary disk 20. At the transition from the valve body 22 to the intermediary disk 20, the central opening 33 here has a smaller diameter than the bore 30, thus producing a stop shoulder on the intermediary disk 20, which serves as a stroke stop for the hollow needle 35 during its opening stroke motion. The spring collar 33 protrudes into a spring chamber 52, which is provided in the valve holding body 17 and contains a closing spring 55 under compressive initial stress. The closing spring 55 here is supported at the end oriented away from the combustion chamber against a supporting ring 57 and is supported at its end oriented toward the combustion chamber against the spring collar 50 so that the initial stress of the closing spring 55 exerts a closing force on the hollow needle 35 in the direction toward the valve seat 46. The spring chamber 52 has a leakage connection 53 to which a leakage line 65 is connected so that the spring chamber 52 is always connected to the fuel tank 1 and is therefore not pressurized.

A valve needle in the form of an inner needle 37 is guided so that it can move longitudinally inside the hollow needle 35 and at its end oriented toward the combustion chamber, has a conical pressure surface 48, which is bordered by a sealing edge 44. In the closed position of the inner needle 37, the sealing edge 44 rests against the valve seat 46 and thus disconnects the second row of injection openings 42 from the pressure chamber 32. At its end oriented away from the combustion chamber, the inner needle 37 transitions into a piston rod 61 that passes through the spring collar 50 and the spring chamber 52 into a control chamber 62 that is provided in the valve body 17 further from the combustion chamber than the spring chamber 52. The control chamber 62 contains a moving piston 60, which is guided in a sealed fashion in the control chamber 62 and is embodied in the shape of a cup. The piston 60 is connected to the piston rod 61 so that it moves in the longitudinal direction synchronously with the inner needle 37. The control chamber 62 contains a closing spring 64 that has a compressive initial stress and acts on the inner needle 37 in the closing direction in addition to the hydraulic force that is generated by the pressure prevailing in the control chamber 62.

The fuel injection system also has a low-pressure accumulation chamber 72, in which a predetermined fuel pressure level is maintained, which is significantly lower than the fuel pressure level of the high-pressure accumulation chamber 7. For example, a pressure prevails in the low-pressure accumulation chamber 72 that is at most approximately one fifth the pressure in the high-pressure accumulation chamber 7, which can be more than 100 MPa. A diversion line 70 leads from each high-pressure valve 11 into the low-pressure accumulation chamber 72 so that the high-pressure valve 11, as a 3/2-port directional-control valve, connects and disconnects the high-pressure line 9 leading from the high-pressure accumulation chamber 7, the high-pressure line 9 to the fuel injection valve 15, and the diversion line 70. The high-pressure valve 11 can be moved into two switched positions. In the first position, which is shown in FIG. 1, the high-pressure valve 11 connects the high-pressure line 9 leading from the fuel injection valve 15 to the diversion line 70, while the connection to the high-pressure accumulation chamber 7 is closed. In the second position of the high-pressure valve 11, the high-pressure accumulation chamber 7 is connected via the high-pressure line 9 to the pressure chamber 32 of the fuel injection valve 15, while the diversion line 70 is closed. The first position of the high-pressure valve 11 corresponds to the position in which no fuel is to be injected into the combustion chamber of the engine, whereas the second position is selected during the injection of fuel.

The low-pressure accumulation chamber 72 is connected to the fuel tank 1 via a leakage line 76; a pressure maintenance valve 74 is provided in the leakage line 76 so that a predetermined fuel pressure level is always maintained in the low-pressure accumulation chamber 72. From the low-pressure accumulation chamber 72, a control line 80 leads to a low-pressure valve 78, which is embodied as a 3/2-port directional-control valve. Downstream of the low-pressure valve 78, the control line 80 divides into a number of branches that corresponds to the number of fuel injection valves and feeds into the control chamber 62 of each of the fuel injection valves 15. A leakage line 82 that is connected to the fuel tank 1 also feeds the low-pressure valve 78. In the first position of the low-pressure valve 78, which is shown in FIG. 1, the control line 80 coming from the control chamber 62 is connected to the leakage line 82, while the control line 80 coming from the low-pressure accumulation chamber 72 is closed. As a result, the control chamber 62 is connected to the fuel tank 1 and is therefore switched into an unpressurized state. In the second position of the low-pressure valve 78, the low-pressure accumulation chamber 72 is connected to the control chamber 62 via the control line 80, while the leakage line 82 is closed. As a result, the fuel pressure of the low-pressure accumulation chamber 72 prevails in the control chamber 62. The fuel injection apparatus must be provided with a high-pressure valve 11 for each fuel injection valve 15, but only one low-pressure valve 78 is required for the entire fuel injection apparatus.

The fuel injection system functions as follows: in the partial load range of the engine, only a relatively small amount of fuel is injected into the combustion chamber of the engine. Consequently, only a part of the total injection cross section should be opened at the given injection pressure. To this end, the low-pressure valve 78 is moved into the second position so that the low-pressure accumulation chamber 72 is connected to the control chamber 62 of all the fuel injection valves 15 so that a hydraulic force is exerted on the piston 60, thus pushing the piston rod 61 and therefore the inner needle 37 in the closing direction. To initiate the injection, the high-pressure valve 11 is moved into the second position so that the high-pressure accumulation chamber 7 is connected to the pressure chamber 32 via the high-pressure line 9 and the inlet conduit 18. As a result, highly pressurized fuel flows into the pressure chamber 32 and exerts a hydraulic force on the pressure shoulder 39 of the hollow needle 35. As soon as this hydraulic force on the pressure shoulder 39 exceeds the force of the closing spring 55, the hollow needle 35 moves away from the valve seat 46 and lifts its sealing edge 43 up from the valve seat 46. This connects the pressure chamber 32 to the first row of injection openings 41 and fuel is injected through them, into the combustion chamber of the engine. Since the fuel pressure now acts on the pressure surface 48 as well, this also exerts a hydraulic force on the inner needle 37 in the opening direction. However, the fuel pressure in the control chamber 62 compensates for this hydraulic force so that the inner needle 37 remains in the closed position. If the injection is to be terminated, then the high-pressure valve 11 is moved back into the first position so that the connection to the high-pressure accumulation chamber 7 is disconnected. The pressure chamber 32 is then connected via the inlet conduit 18 and the high-pressure line 9 to the diversion line 70 and therefore to the low-pressure accumulation chamber 72. The residual pressure in the pressure chamber 32 is then discharged into the low-pressure accumulation chamber 72, thus producing a diversionary flow into the low-pressure chamber 72, which increases the fuel pressure there. As soon as the fuel pressure in the low-pressure accumulation chamber 72 exceeds a predetermined level, the pressure maintenance valve 74 opens and fuel flows out of the low-pressure accumulation chamber 72 and back into the fuel tank 1. As a result of the subsequently falling pressure in the pressure chamber 32, the hydraulic force on the pressure shoulder 39 also decreases and the force of the closing spring 55 pushes the hollow needle 35 back into the closed position, once again closing the injection openings 41. The leakage flows that occur due to the high pressure differential between the pressure chamber 32 and the spring chamber 52 and that flow into the spring chamber 52 are diverted here via the leakage line 65 so that the fuel pressure level of the fuel tank 1 is maintained in the spring chamber 52. If the engine is to be operated at full load, then both rows of injection openings 41, 42 are opened. To this end, the low-pressure valve 78 is switched into the first position so that the control chamber 62 is then pressure-relieved via the control line 80 and the leakage line 82. The first part of the injection then occurs, as described above, in partial load operation, but then after the hollow needle 35 has traveled into the open position, the exertion of pressure on the pressure surface 48 also moves the inner needle 37 into the open position so that the second row of injection openings 42 are also opened and fuel flows out of the pressure chamber 32 through the entire injection cross section. In this type of operation, only the force of the closing spring 64 acts on the inner needle 37 so that the hydraulic pressure on the pressure surface 48 is now sufficient to produce an opening stroke movement. The injection is terminated as described above by switching the high-pressure valve 11.

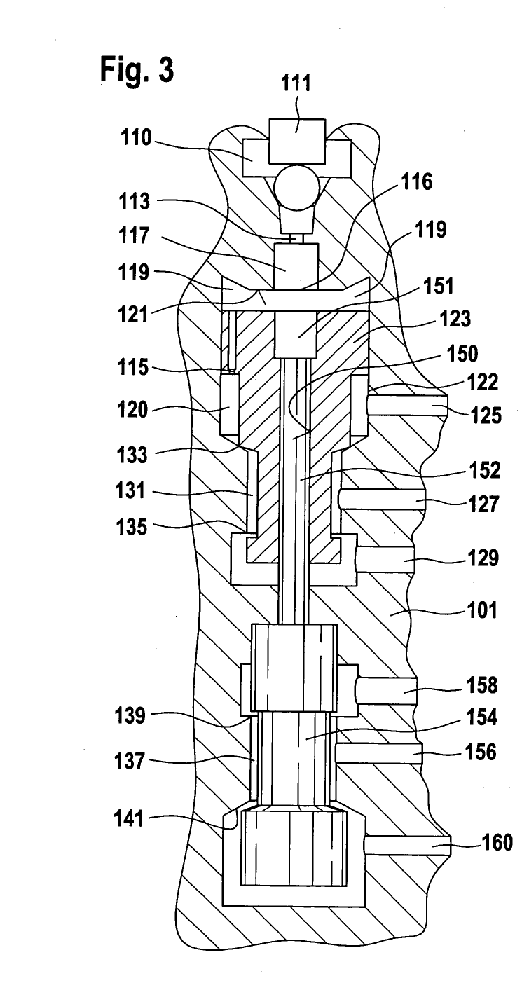

FIG. 3 shows a control valve device, which can be integrated into a valve housing 101 that corresponds to the valve housing 16 in FIG. 1 and which, according to the invention, can be used to replace the two separate, electrically triggerable control valves 11 and 78; this allows each combustion chamber and each injector to be associated with a separate valve for triggering the respective inner needle. In this connection, a servohydraulic 3/2-for directional-control valve 131 is provided with a control piston 123, which is supported in a mobile fashion and closes a control chamber 116 that can be filled with fuel off from a high-pressure chamber 120. The control chamber has a first partial region 117, which can be emptied via an outlet throttle 113 and a connecting line 110; the connecting line 110 contains a for example electrically triggerable piezoelectric or solenoid valve 111. The control piston 123 is embodied as cylindrical and can move in a bore of the valve housing 101, guided by the wall 122 of the bore. At the other end from the control chamber 116, the control piston transitions into a smaller-diameter region, which produces the high-pressure chamber 120 between the wall 122 and the control piston, which high-pressure chamber 120 is connected to a connecting line 125. In each position of the control piston, the high-pressure chamber 120 is connected to a second partial region 119 of the control chamber 116 via an inlet throttle 115 integrated into the control piston 123 in the form of a bore. Between the first and second partial region 117 and 119 of the control chamber 116, a wall is provided that extends perpendicular to the movement direction of the control piston and functions as a stroke stop 121 for the control piston. The high-pressure chamber 120 extends over a conical tapering of the bore in the valve housing 101. The control piston 123 also has a corresponding conical tapering so that the control piston and the wall 122 in the vicinity of the conically tapered sections constitute a first sealing region 133, thus allowing a partial region of the high-pressure chamber on other side of the conical tapering, which is connected to a connecting line 127, to be disconnected from the part of the high-pressure chamber connected to the line 125; the sealing region 133 is thus embodied as a seat valve. On the other side of the sealing region 133, at the end oriented away from the control chamber, the control piston transitions back into a larger-diameter region; the part of the high-pressure chamber connected to the line 127 also opens out into a larger-diameter region, which is connected to a return line 129. The diameters of the wall and the control piston in the region of the transition, i.e. the second sealing region 135, are embodied so that the control piston 123 can function as a slide valve in the second sealing region 135 in order to connect the line 127 to the line 129 or disconnect them, as needed. The control piston 123 also has a central bore 150 extending parallel to the movement direction of the piston, which at its end oriented toward the control chamber, transitions into a larger-diameter central recess 151, whose space constitutes part of the first partial region 117 of the control chamber 116. A control rod 152 guided in the central bore 150 in a movable fashion that is fluid tight, except for leakage losses. The control rod is acted on by a fuel pressure prevailing in the first partial region of the control chamber and transmits this to the second control piston 154 of the second 3/2-port directional-control valve 137, which is likewise integrated into the housing 101. It has a third sealing region 139 and a fourth sealing region 141; analogous to the sealing region 135, the sealing region 139 is embodied as a slide valve and, analogous to the sealing region 133, the sealing region 141 is embodied as a seat valve so that the connecting line 156 situated between the two sealing regions 139 and 141 can be connected to the additional return line 158 or the connecting line 160 or can be disconnected from the respective line 158 or 160.

If the valve device described in the preceding section is used as a replacement for the separate valves 11 and 78 (see FIG. 1), then the servohydraulic valve 131 performs the function of the valve 11. Correspondingly, the connecting line 125 (labeled as line 9 in FIG. 1) leads to the high-pressure accumulation chamber 7 and the connecting line 127 (likewise labeled line 9 in FIG. 1) leads to the pressure chamber 32 of the injector. The return line 129 corresponds to the line 70 in FIG. 1 and leads to the low-pressure accumulation chamber 72. The second control valve 137, which can be triggered by the control rod 152, replaces the valve 78. In this case, the return line 158 corresponds to the line 82 in FIG. 1, the connecting line 156 corresponds to the line 80 leading to the control chamber 62 of the injector, and the connecting line 160 corresponds to the line 80 leading from the low-pressure accumulation chamber 72. In the position shown, the pressure chamber 32 of the injector is connected to the return while being disconnected from the high fuel pressure of the high-pressure accumulation chamber, which prevails in the connecting line 125. If the solenoid valve 111 is closed, then the fuel pressure of the high-pressure accumulation chamber 7 also prevails in the control chamber 116 via the inlet throttle 115 and, as a result of the larger control piston surface area in the control chamber in comparison to the high-pressure chamber 120, the control piston 123 rests against the wall 122 in the first sealing region. This means that the outer needle 35 of the injector keeps the injection openings closed. The opening process is executed by means of the system comprising the inlet throttle, the stroke stop, the outlet throttle, and the solenoid valve: if the solenoid valve is opened, then the pressure in the control chamber 116 decreases since the inlet and outlet throttles function together as a pressure distributor. As a result, the compressive force on the control chamber end of the control piston decreases and the control piston moves toward the stroke stop 117, as a result of which on the one hand, the connection opens between the high-pressure accumulation chamber and the pressure chamber 32 and on the other hand, the pressure chamber 32 is disconnected from the return line. As a result, the pressure in the pressure chamber 32 of the injector increases and the outer needle 35 unblocks the injection openings 41. If the control piston 123 reaches the stroke stop 121, then this throttles the flow to the outlet throttle 113, which results in an increase in the fuel pressure in the second partial region 119 of the control chamber 116 and a significant decrease in the pressure in the first partial region 117. If the solenoid valve 111 is closed again, then the pressure increases in both partial regions of the control chamber 116 and the control piston moves back into the starting position shown in FIG. 3. The second control valve 137 opens the inner needle 37. If the solenoid valve 111 is closed, then in the static state, the high fuel pressure of the high-pressure accumulation chamber prevails in the vicinity of the central recess 151 in the end surface of the control rod 152, as a result of which the second control piston 154 is held in such a position that, as shown in FIG. 3, the connecting line 156 and therefore the control chamber 62 of the inner needle 37 is disconnected from the return line and is connected to the low-pressure chamber 72 so that the inner needle holds the injection openings 42 closed. If the solenoid valve 111 is open, then the pressure in the control chamber 116 decreases. As soon as the control piston 123 has reached the stroke stop 121, then a narrow region between the stroke stop and the end surface of the control piston 123 functions as a throttle restriction between the inlet throttle 115 and the outlet throttle 113, and the pressure in the first partial region 117 of the control chamber decreases to a minimal value. The stroke required to open the connection between the return line 158 and the connecting line 156 is selected so that the second control valve 137 opens in the third sealing region 139 and closes in the fourth sealing region 141 when the control piston 123 reaches the stroke stop 121. The opening of the inner needle 37 occurs a certain amount of time after the opening of the outer needle 35, depending on the fuel pressure in the high-pressure accumulation chamber and on the pressure distribution produced by the inlet and outlet throttles 115. If the solenoid valve is closed, then the control piston moves back away from the stroke stop 121, the pressure in the chamber 151 increases, the control piston 154 closes the seat 139 leading to the return line 158, the inner needle 37 closes the injection openings 42, and a short time later, the outer needle also closes (as has just been described above).

Alternative to or in addition to definitely establishing the cross section of the inlet and outlet throttles 115 and 113, it is also possible to vary the time duration between the opening of the outer needle and the opening of the inner needle in such a way that the solenoid valve is triggered in a synchronized fashion so that the control piston does not have time to reach the stroke stop 121 and therefore, only the outer needle unblocks the injection openings, as long as a synchronized triggering occurs within the period in which the intent is for only the outer needle to unblock injection openings. The valve device described, in which the control chamber pressure is used for two valves, can also be used for other purposes, e.g. for switching a pressure booster on and off with the aid of the second control valve 137.

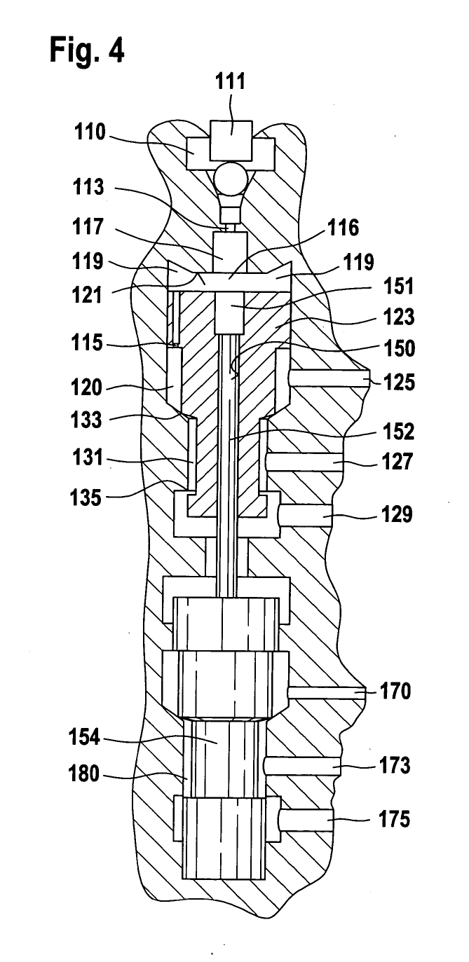

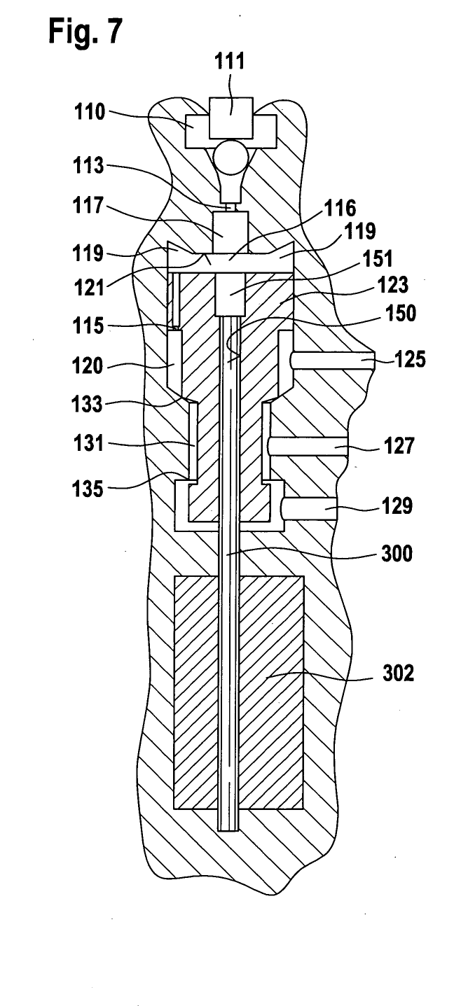

FIGS. 4 and 7 show alternative exemplary embodiments in which components that are the same or similar to those in FIG. 3 are provided with the same reference numerals and are not described again. In these figures and the ones described below, the valve housing 101 has been omitted for the sake of simplicity.

In the embodiment according to FIG. 4, the control valve 137 from FIG. 3 has been replaced by a 3/2-port directional-control valve 180 in which in the non-triggered switched state, the high-pressure line 170 is disconnected from the connecting line 173 by the closed seat valve part of the valve 180, while a hydraulic connection to the return line 175 is produced.

The function is the same as in the device according to FIG. 3, the only difference is that when the valve device is not triggered, the high-pressure-suited seat valve part of the control valve 180 is not open, but closed.

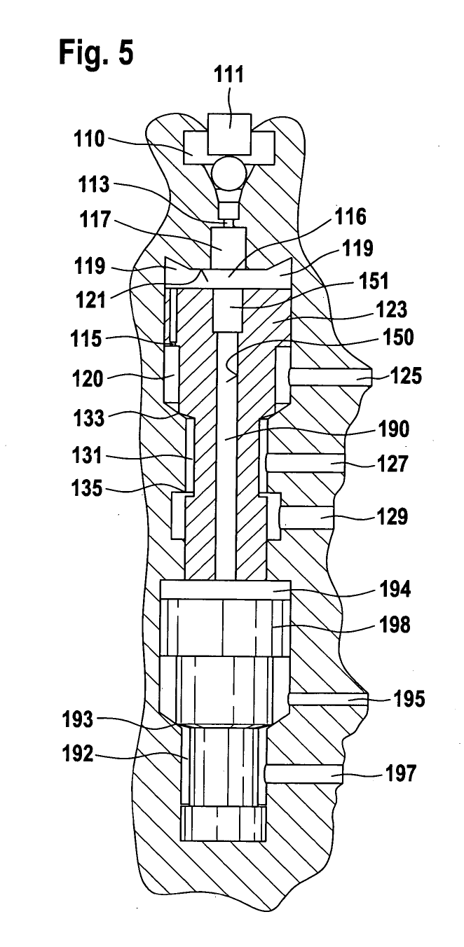

FIG. 5 shows a valve device in which, by contrast to the one in FIG. 4, the compressive force is transmitted to a second control valve not by means of the control rod, but by means of 80 fuel column in the bore 150 of the control piston 123, which bore is embodied in the form of the connecting conduit 190. The second control valve in this instance is embodied as a 2/2-port directional-control valve 192; when the valve device is not triggered, the sealing region 193 of the 2/2-port directional-control valve, which region is embodied as a seat valve, disconnects the high-pressure connection and the high-pressure line 195 from the connecting line 197. The control chamber 194 disposed upstream of the control piston 198 of the 2/2-port directional-control valve continuously communicates with the connecting conduit 190; the control chamber 194 is bounded by the control piston 123.

This embodiment also involves the operating principle of using the pressure in the partial region 117 of the control chamber 116 simultaneously for an additional valve, in this instance for the 2/2-port directional-control valve 192.

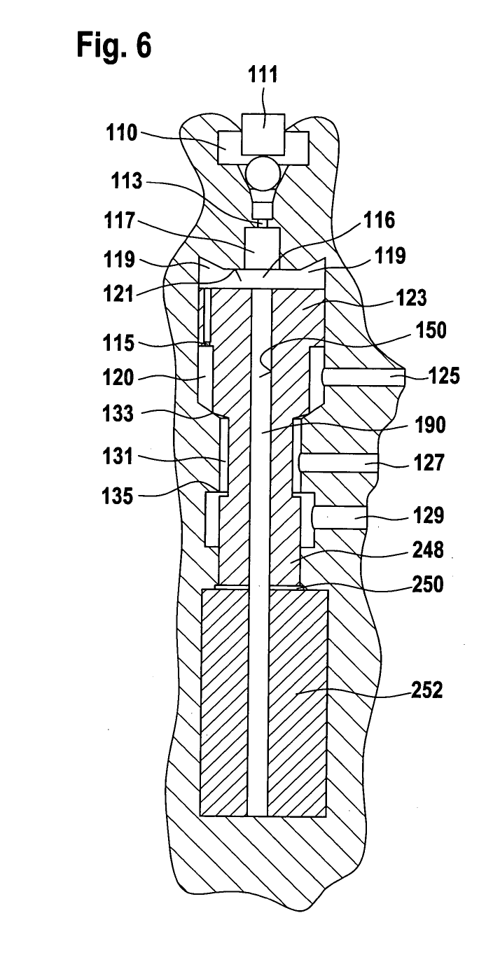

FIG. 6 shows an embodiment in which the lower end 248 of the control piston 123 oriented away from the control chamber 116 protrudes into an intermediary chamber that is bounded at the other end by a body 252.

Here, too, the control piston can execute its required control movements in the intermediary chamber; at the same time, the bore extending in the body 252 serves to transmit the fuel pressure in the partial region 117 of the control chamber to any other actuator.

Therefore in other alternative embodiments, the bore 150 can be used to transmit the fuel pressure prevailing in the partial region 117 to another control valve. In addition, other moving elements can be triggered by means of the fuel pressure prevailing in the bore of the body 252, for example a pressure boosting device, a moving element for adjusting variable stroke stops of a control valve, or a moving element for transmitting an additional closing force to the valve element, particularly at the beginning of a closing procedure.

In another alternative embodiment, instead of being embodied as a 3/2-port directional-control valve (as shown in FIGS. 3 to 6), the servohydraulic valve can also be embodied as a 2/2-port directional-control valve, as long as the specific use of the valve device permits this.

FIG. 7 shows an embodiment in which the servohydraulic valve 131 is embodied essentially the same as the one shown in FIG. 3, but is provided with a control rod 300 that is guided by a guide body 302 outside the valve 131 so that the axial movements of the control rod 300 due to pressure variations in the partial region 117 of the control chamber can be transmitted to any other moving elements.

1. A fuel injection apparatus with a fuel injection valve, wherein the fuel injection valve has at least one injection opening and at least one valve element for closing the at least one injection opening, characterized in that the valve element is controlled by means of a servohydraulic valve (131), that the servohydraulic valve has a control piston (123) that is supported in moving fashion, wherein the control piston disconnects a control chamber (116) from a high-pressure chamber (120), wherein at least one first partial region (117) of the control chamber (116) can be emptied in every position of the control piston (123) via a line (110) provided with an outlet throttle (113), and wherein at least one second partial region (119) of the control chamber can be filled with fuel in every position of the control piston via an inlet throttle (115) so that depending on the filling of the control chamber (116), in a first position, the control piston (123) disconnects a first connection (125) of the high-pressure chamber from a second connection (127) of the high-pressure chamber and in a second position, connects the first connection to the second connection so that the valve element (35) can be controlled in accordance with the position of the control piston (123), wherein means (150, 151, 152, 137; 150, 151, 152, 180; 150, 190, 192; 150, 190, 250, 252; 150, 151, 300, 302) are provided in order to be able to use the fuel pressure prevailing in at least one of the partial regions (117, 119) of the control chamber (116) for controlling another moving element (37) of the fuel injection apparatus.

2. The fuel injection apparatus according to claim 1, characterized in that the other moving element is another valve element (37) of the fuel injection valve.

3. The fuel injection apparatus according to claim 2, characterized in that the other valve element is an inner needle (37) supported coaxial to the at least one valve element.

4. The fuel injection apparatus according to claim 1, characterized in that the means include a bore (150) in the control piston (123) via which the fuel pressure prevailing in one of the partial regions can be transmitted to another actuator, in particular to a second control valve (137).

5. The fuel injection apparatus according to claim 1, characterized in that the servohydraulic valve is a 3/2-port directional-control valve (131).

6. The fuel injection apparatus according to claim 1, characterized in that the pressure prevailing in the first partial region (117) can be used for controlling the other moving element.

7. The fuel injection apparatus according to claim 1, characterized in that the inlet throttle (115) is integrated into the control piston (123).

8. The fuel injection apparatus according to claim 1, characterized in that the means include a 3/2-port directional-control valve (137, 180) or a 2/2-port directional-control valve (192).

9. The fuel injection apparatus according to claim 1, characterized in that the servohydraulic valve is connected to a high-pressure accumulation chamber (7).

10. The fuel injection apparatus according to claim 1, characterized in that the means are connected to a low-pressure accumulation chamber (72).

11. The fuel injection apparatus according to claim 1, characterized in that the servohydraulic valve has a valve (111) that can be electrically triggered.

12. The fuel injection apparatus according to claim 11, characterized in that the electrically triggerable valve can close the line (110) provided with the outlet throttle (113).

13. The fuel injection apparatus according to claim 11, characterized in that the electrically triggerable valve is a solenoid valve or a piezoelectrically triggerable valve.
